(19) United States
(12) Patent Application Publication
(10) Pub. No.: US 2026/0204740 A1
(43) Pub. Date: Jul. 16, 2026

(54) BATTERY PACK MANUFACTURING METHOD

(71) Applicant: TOYOTA JODOSHA KABUSHIKI KAISHA, Toyota-shi (JP)

(72) Inventors: Tomo FUKAMI, Nagoya-shi (JP); Shunsuke ISOBE, Okazaki-shi (JP); Yoshinori SHIBATA, Nagoya-shi (JP); Takumi SHIGENO, Toyota-shi (JP)

(73) Assignee: TOYOTA JODOSHA KABUSHIKI KAISHA, Toyota-shi (JP)

(21) Appl. No.: 19/300,991

(22) Filed: Aug. 15, 2025

(30) Foreign Application Priority Data
Jan. 16, 2025 (JP) 2025-006387

(51) Int. Cl. H01M 50/516; H01M 50/503; H01M 50/522

(52) U.S. Cl. CPC H01M 50/516; H01M 50/503; H01M 50/522

(57) ABSTRACT

In a battery pack manufacturing method, in a state in which, in a width direction of a plurality of battery cells arrayed adjacently to each other in the width direction, a concave portion provided on a welding portion of a terminal piece portion that is made of metal and is provided on a portion on one side in the width direction of a case that houses an electrode assembly of a battery cell on another side in the width direction, and a convex portion provided on a welding portion of a terminal piece portion that is made of metal and is provided on a portion on the other side in the width direction of a case that houses an electrode assembly of a battery cell on the one side in the width direction, are fit to each other, the welding portion and the welding portion are welded together.

### CROSS-REFERENCE TO RELATED APPLICATION

This application claims priority to Japanese Patent Application No. 2025-006387 filed on Jan. 16, 2025. The disclosure of the above-identified application, including the specification, drawings, and claims, is incorporated by reference herein in its entirety.

### BACKGROUND

### 1. Technical Field

The present disclosure relates to a battery pack manufacturing method.

### 2. Description of Related Art

WO 2017/130706 discloses an disclosure related to a power supply device. In this power supply device, when welding a bus bar to an electrode terminal that is provided on an upper part of a battery cell, the bus bar is pressed against the battery cell using a jig.

### SUMMARY

However, when the above related art is adopted in a power supply device including battery cells with electrode terminals that are provided on sides thereof, there is a need to secure space between the battery cells to dispose a jig when welding the bus bar and the electrode terminal, which is undesirable from the perspective of energy density of an electricity storage device. That is to say, the above related art has room for improvement in terms of stably connecting the electrodes provided on the sides of the battery cells to each other, while ensuring energy density.

In view of the above circumstances, an object of the present disclosure is to provide a battery pack manufacturing method, in which electrodes provided on the sides of battery cells can be stably connected to each other while ensuring energy density.

Between a first battery cell and a second battery cell that are arrayed adjacently to each other in an array direction, in a state in which a concave portion, provided in a first welding portion of a first terminal piece portion that is made of metal and is provided on a portion of a first case that houses a first electrode assembly of the first battery cell, on one side in the array direction, and that also is electrically connected to the first electrode assembly, and a convex portion, provided in a second welding portion of a second terminal piece portion that is made of metal and is provided on a portion of a second case that houses a second electrode assembly of the second battery cell, on another side in the array direction, and that also is electrically connected to the second electrode assembly, are fit to each other, the first welding portion and the second welding portion are welded together.

According to the battery pack manufacturing method according to a first aspect, the first battery cell and the second battery cell are arrayed in a state adjacent to each other.

Then, in the state in which the concave portion, provided in the first welding portion of the first terminal piece portion that is made of metal and is provided on the portion of the first case that houses the first electrode assembly of the first battery cell, on one side in the array direction, and that also is electrically connected to the first electrode assembly, and the convex portion, provided in the second welding portion of the second terminal piece portion that is made of metal and is provided on the portion of the second case that houses the second electrode assembly of the second battery cell, on another side in the array direction, and that also is electrically connected to the second electrode assembly, are fit to each other in the array direction thereof, the first welding portion and the second welding portion are welded together.

Accordingly, in this aspect, the first welding portion of the first terminal piece portion and the second welding portion of the second terminal piece portion can be welded while keeping the relative positions thereof constant, without using a jig.

As described above, the battery pack manufacturing method according to the present disclosure has the excellent effects of ensuring energy density while stably connecting electrodes, provided on the sides of the battery cells, to each other.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating a configuration of a battery pack that is manufactured by a battery pack manufacturing method according to a first embodiment;

FIG. 2 is a front view schematically illustrating a configuration of a primary portion in a battery cell of the battery pack that is manufactured by the battery pack manufacturing method according to the first embodiment;

FIG. 3 is a perspective view schematically illustrating a configuration of a primary portion in a battery cell of a battery pack according to a second embodiment; and

FIG. 4 is a front view schematically illustrating a configuration of the primary portion in the battery cell of the battery pack according to the second embodiment.

### DETAILED DESCRIPTION OF EMBODIMENTS

### First Embodiment

A configuration of a battery pack according to a first embodiment of the present

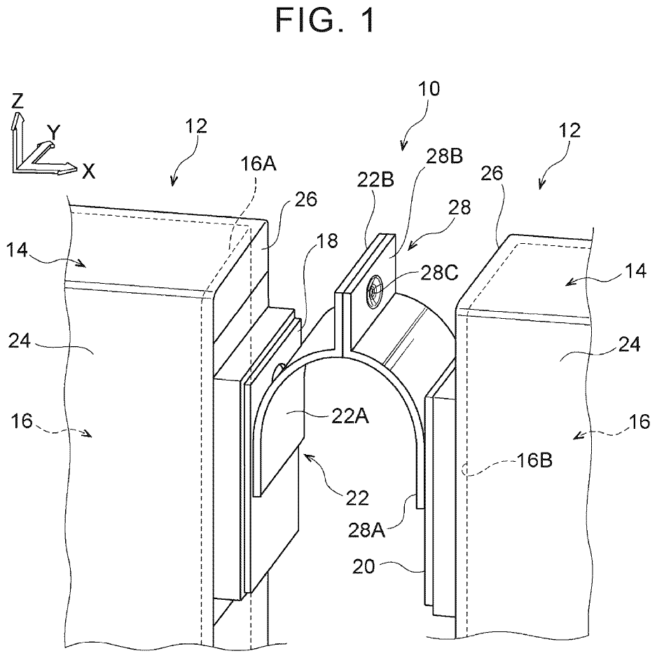

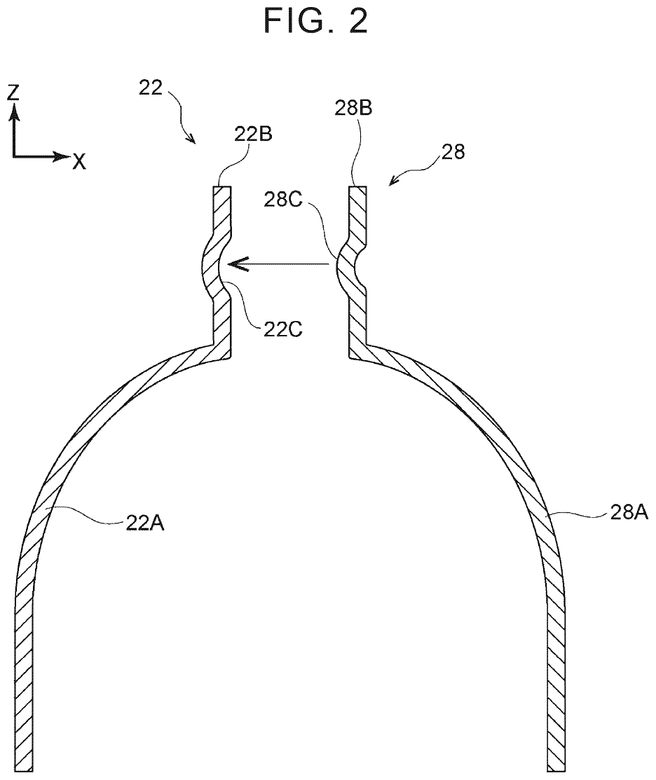

disclosure will be described below with reference to FIGS. 1 and 2. A “battery pack 10” according to the present embodiment can be installed in the underside of a floor portion of a vehicle that is omitted from illustration, such as a hybrid electric vehicle, a plug-in hybrid electric vehicle, a battery electric vehicle, or the like. This battery pack 10 includes an aluminum alloy battery case that makes up an outer shell thereof, and a plurality of “battery cells 12” housed in the battery case.

Note that for the sake of convenience, in each of the drawings in the present embodiment, an arrow X will be referred to as width direction of the battery cell 12 (hereinafter, simply “width direction”), an arrow Y will be referred to as thickness direction of the battery cell 12 (hereinafter, simply “thickness direction”), and an arrow Z will be referred to as height direction of the battery cell 12 (hereinafter, simply “height direction”). Also, one of the width direction, the thickness direction, and the height direction is orthogonal to the two other directions.

As illustrated in FIG. 1, the battery cell 12 includes a “case 14” that makes up an outer shell thereof, an “electrode assembly 16” that is disposed inside the case 14, an anode side current collector terminal that is omitted from illustration, a cathode side current collector terminal that is omitted from illustration, an external terminal 18, an external terminal 20, a “terminal piece portion 22” as a first terminal piece portion, and a “terminal piece portion 28” as a second terminal piece portion.

The case 14 is configured including a case body 24 made of an aluminum alloy that makes up a main portion thereof, and a pair of sealing plates 26 made of an aluminum alloy that makes up end portions in the width direction thereof. The case body 24 has a rectangular tubular shape with both sides open in the width direction.

On the other hand, the sealing plates 26 have a rectangular plate shapes as viewed from the width direction, with a plate thickness direction being the width direction and also a longitudinal direction being the height direction. Opening portions of the case body 24 are sealed off by the sealing plates 26. That is to say, the sealing plates 26 make up part of sides of the battery cell 12.

The electrode assembly 16 includes a power generating element that makes up a main portion thereof and also functions as a storage unit for electric power in the battery cell 12, an anode current collector 16A, and a cathode current collector 16B.

The anode current collector 16A makes up an end portion on one side of the electrode assembly 16 in the width direction, and the cathode current collector 16B makes up an end portion on the other side of the electrode assembly 16 in the width direction.

The anode side current collector terminal is made of copper as one example, and a main portion thereof is housed in one side of the case 14 in the width direction. The anode side current collector terminal is joined to the anode current collector 16A of the electrode assembly 16 at a joining portion, omitted from illustration, made by resistance welding or the like, and is in a state of being electrically connected to the anode current collector 16A.

On the other hand, the cathode side current collector terminal is made of aluminum as one example, and a main portion thereof is housed in the other side portion of the case 14 in the width direction. This cathode side current collector terminal is joined to the cathode current collector 16B of the electrode assembly 16 at a joining portion, omitted from illustration, made by resistance welding or the like.

The external terminal 18 is in the form of a rectangular plate as viewed in the width direction, is made of copper as one example, in the same way as the anode side current collector terminal, and is also disposed on the sealing plate 26 on one side in the width direction, at a portion on an upper side thereof in the height direction. Note that the external terminal 18 is electrically connected to the anode side current collector terminal.

On the other hand, the external terminal 20 is made of aluminum as one example, in the same way as the cathode side current collector terminal, and is also disposed on the sealing plate 26 on the other side in the width direction, at a portion on an upper side thereof in the height direction. Note that the external terminal 20 is electrically connected to the cathode side current collector terminal. The external terminal 18 is provided with the terminal piece portion 22, and the external terminal 20 is provided with the terminal piece portion 28.

As illustrated in FIG. 2, the terminal piece portion 22 is formed by bending a metal plate material by pressing or the like, and is configured including a joining portion 22A and a “welding portion 22B” serving as a first welding portion.

Specifically, a portion on a lower side of the joining portion 22A in the height direction extends linearly in the height direction, and also an upper side portion in the height direction is curved so as to be convex toward an inner side in the width direction of the battery cell 12 and also toward an upper side in the height direction. Note that the joining portion 22A is welded to the external terminal 18.

On the other hand, the welding portion 22B is provided integrally with the joining portion 22A and also has a flat shape extending upward in the height direction from the joining portion 22A with the thickness direction being the width direction. Also, when the welding portion 22B of the terminal piece portion 22 that is configured as described above is pressed toward the inner side in the width direction of the battery cell 12, restoring force thereof can apply a biasing force from the welding portion 22B to the outer side in the width direction of the battery cell 12.

Further, the welding portion 22B is formed with a spherical “concave portion 22C” that is convex toward the case 14 side.

On the other hand, the terminal piece portion 28 has a structure basically similar to that of the terminal piece portion 22, including a joining portion 28A and a “welding portion 28B” serving as a second welded portion. Note that the joining portion 28A is welded to the external terminal 20.

Further, the welding portion 28B is formed with a “convex portion 28C” that is spherical and protrudes toward the side opposite the case 14, and that can also fit into the concave portion 22C. Note that the concave portion 22C and the convex portion 28C may have various types of shapes, such as a cuboid outer shape or the like, as long as they are shapes that are capable of being fit together.

Further, the battery cells 12 are disposed in a row in the width direction, and in the present embodiment, the width direction can be regarded as being a direction of array of the battery cells 12. In the battery cells 12 that are disposed adjacent to each other in the width direction, a distal end portion of the terminal piece portion 22 and a distal end portion of the terminal piece portion 28 are joined at a joining portion that is omitted from illustration, by laser welding or the like, in a state in which the concave portion 22C of the terminal piece portion 22 and the convex portion 28C of the terminal piece portion 28 that are adjacent to each other are fitted together, such that the battery cells 12 disposed adjacently to each other in the width direction are electrically connected to each other.

Note that in the present embodiment, among the battery cells 12 that are disposed adjacently to each other in the width direction, the battery cell 12 that is located on the other side in the width direction functions as a first battery cell, and the battery cell 12 that is located on the one side in the width direction functions as a second battery cell.

In the battery cell 12 functioning as the first battery cell, the electrode assembly 16 functions as a first electrode body, and the case 14 functions as a first case.

On the other hand, in the battery cell 12 functioning as the second battery cell, the electrode assembly 16 functions as a second electrode assembly, and the case 14 functions as a second case.

### Effects and Advantages of the Present Embodiment

Next, the effects and advantages of the present embodiment will be described.

In a manufacturing method of the battery pack 10 according to the present embodiment, as illustrated in FIG. 1, the battery cells 12 are arrayed in a state adjacent to each other in the width direction in the battery case. Also, the concave portion 22C that is provided in the welding portion 22B of the terminal piece portion 22 which is made of metal and is provided in one width direction side portion of the case 14 that houses the electrode assembly 16 of the battery cell 12 on the other width direction side and is also electrically connected to the electrode assembly 16, and the convex portion 28C that is provided in the welding portion 28B of the terminal piece portion 28 which is made of metal and is provided in the other width direction side portion of the case 14 that houses the electrode assembly 16 of the battery cell 12 on one width direction side and is also electrically connected to the electrode assembly 16, are fitted together in the width direction, and then the welding portion 22B and the welding portion 28B are welded in a state in which the concave portion and the convex portion are fitted together.

Accordingly, according to the present embodiment, the battery cells 12 that are arrayed adjacently to each other in the width direction can be welded while maintaining constant the relative position between the welding portion 22B of the terminal piece portion 22 on the other side in the width direction and the welding portion 28B of the terminal piece portion 28 on the one side in the width direction, without using a jig.

As described above, according to the present embodiment, the electrodes that are provided on the sides of the battery cells 12 can be stably connected to each other, while ensuring the energy density of the battery pack 10.

### Second Embodiment

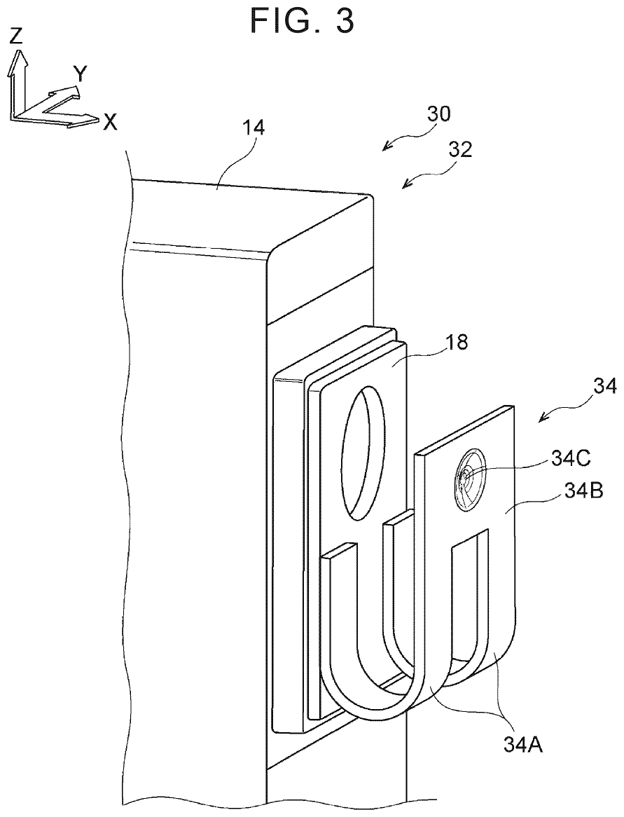

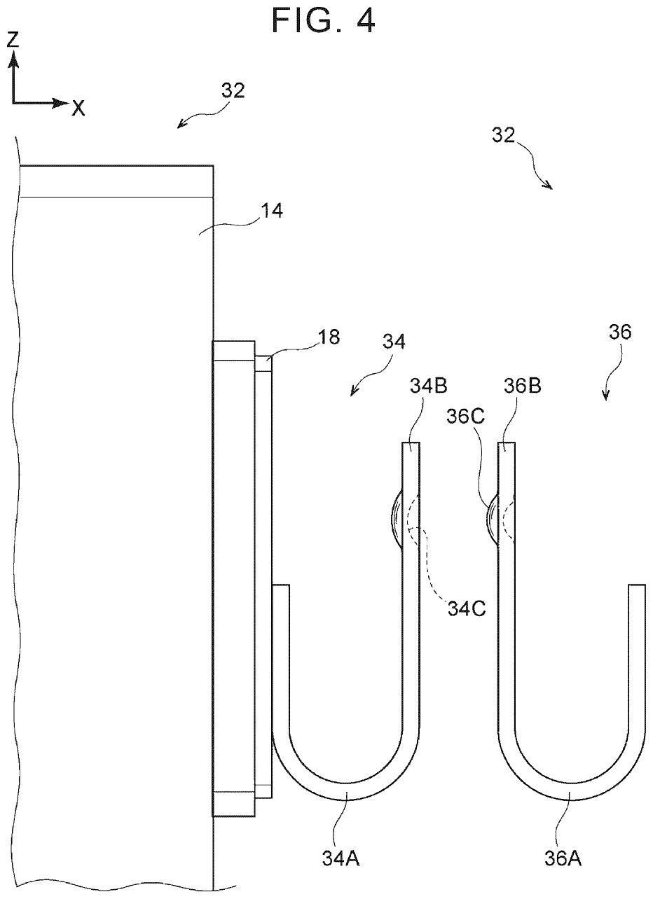

A “battery pack 30” according to a second embodiment of the present disclosure will be described below with reference to FIGS. 3 and 4. Note that the same components as those in the first embodiment described above are denoted by the same reference numerals, and description thereof will be omitted.

This battery pack 30 is basically configured in the same manner as the first embodiment that is described above, however, the shape of a “terminal piece portion 34” serving as the first terminal piece portion that is provided on a “battery cell 32” is different from the shape of the terminal piece portion 22, and the shape of a “terminal piece portion 36” serving as the second terminal piece portion is different from the shape of the terminal piece portion 28.

The terminal piece portion 34 is formed by bending a metal plate material by pressing or the like, and includes a pair of joining portions 34A and a “welding portion 34B” serving as a first welding portion.

Specifically, the joining portions 34A are U-shaped with a lower side in the height direction being convex as viewed from the thickness direction, and are disposed across a spacing from each other in the thickness direction, with the portions thereof on the case 14 side being welded to the external terminal 18.

On the other hand, the welding portion 34B is provided continuous from the joining portions 34A at the opposite side portion from the case 14, and is also flat and extends upward in the height direction from the joining portions 34A with the thickness direction as the width direction. Further, the welding portion 34B is formed with a “concave portion 34C” having the same shape as the concave portion 22C.

On the other hand, the terminal piece portion 36 includes a pair of joining portions 36A and a “welding portion 36B” as a second welding portion, and has a configuration similar to that of the terminal piece portion 34. Also, the welding portion 36B is formed with a “convex portion 36C” having the same shape as the convex portion 28C.

According to this configuration, basically the same effects and advantages as those of the first embodiment that is described above are achieved. Also, according to the present embodiment, the joining portions 34A and the joining portions 36A are U-shaped with the lower side in the height direction being convex as viewed from the thickness direction, and accordingly the amount of deformation in the width direction of the terminal piece portion 34 and the terminal piece portion 36 can be ensured.

What is claimed is:

1. A battery pack manufacturing method, wherein,
between a first battery cell and a second battery cell that are arrayed adjacently to each other in an array direction,
in a state in which a concave portion, provided in a first welding portion of a first terminal piece portion that is made of metal and is provided on a portion of a first case that houses a first electrode assembly of the first battery cell, on one side in the array direction, and that also is electrically connected to the first electrode assembly, and
a convex portion, provided in a second welding portion of a second terminal piece portion that is made of metal and is provided on a portion of a second case that houses a second electrode assembly of the second battery cell, on another side in the array direction, and that also is electrically connected to the second electrode assembly, are fit to each other,
the first welding portion and the second welding portion are welded together.
